(19) United States
(12) Patent Application Publication
(10) Pub. No.: US 2026/0358670 A1
(43) Pub. Date: Nov. 12, 2026

(54) OPTICAL COMPUTING DEVICE, AND ADJUSTMENT METHOD OF MACH-ZEHNDER INTERFEROMETER IN OPTICAL COMPUTING DEVICE

(71) Applicant: Mitsubishi Electric Corporation, Tokyo (JP)

(72) Inventor: Mizuki SHIRAO, Tokyo (JP)

(73) Assignee: Mitsubishi Electric Corporation, Tokyo (JP)

(21) Appl. No.: 19/716,583

(22) Filed: Jun. 23, 2026

Related U.S. Application Data
(63) Continuation of application No. PCT/JP2024/005639, filed on Feb. 19, 2024.

(51) Int. Cl. G02F 1/21; G06E 1/04

(52) U.S. Cl. CPC G02F 1/212; G06E 1/045; G02F 2201/06

(57) ABSTRACT

An optical computing device includes: a multi-stage MZI array configured by arranging, in even-numbered rows, Mach-Zehnder Interferometers arranged in odd-numbered columns, and arranging, in odd-numbered rows, Mach-Zehnder interferometers arranged in even-numbered columns in a matrix of a plurality of rows and a plurality of columns to arrange the Mach-Zehnder Interferometers in a rectangular shape; and Monitor Photodetectors connected to first output ports Port3 of Mach-Zehnder Interferometers arranged in a first row.

### CROSS REFERENCE TO RELATED APPLICATION

This application is a Continuation of PCT International Application No. PCT/JP2024/005639, filed on Feb. 19, 2024, which is hereby expressly incorporated by reference into the present application.

### TECHNICAL FIELD

The present disclosure relates to an optical computing device that includes a multi-stage MZI array configured by arranging Mach-Zehnder Interferometers (MZI) of multiple stages in a rectangular shape, and an adjustment method of the MZIs in the optical computing device.

### BACKGROUND ART

Non-Patent Literature 1 describes a Clements mesh that is more compact and causes less optical loss than a Reck mesh employing a triangular arrangement configuration, and that employs a rectangular arrangement configuration as a multiport interferometer mesh in an optical computation circuit that uses an analog computing technique that performs a linear operation using an interference of light traveling through an optical waveguide.

The Clements mesh described in Non-Patent Literature 1 includes MZIs having N inputs, N outputs detectors, and M columns.

The number of MZIs arranged in odd-numbered columns is N/2, and the number of MZIs arranged in even-numbered columns is (N/2−1).

Furthermore, calibration for compensating for a phase error due to manufacturing variations of each MZI of the Clements mesh described in Non-Patent Literature 1 is performed first on MZIs in order from MZIs in the lowermost row toward MZIs in an uppermost row along the longest diagonal line in the mesh, then is performed on MZIs in order toward the MZIs in the uppermost row along a line connecting MZIs in a row that is one row above the lowermost row except the MZIs in the lowermost row with respect to the diagonal line, is performed in order toward the MZIs in the uppermost row along a line connecting MZIs in a last column likewise, and is performed on odd-numbered rows in order likewise.

### Citation List

### Non-Patent Literature

Non-Patent Literature 1: Christopher Alexiev et al. “Calibrating rectangular interferometer meshes with external photodetectors” OSA Continuum vol. 4, N0.11/15 Nov. 2021.P.P.2892-2904

### SUMMARY OF INVENTION

### Technical Problem

The Clements mesh described in Non-Patent Literature 1 is configured as described above, and therefore takes a longer calibration time for all MZIs.

Furthermore, the Clements mesh described in Non-Patent Literature 1 is configured starting from an MZI at a tail of a plurality of coupled MZIs, and therefore a light intensity to be detected becomes very weak depending on an initial condition, and configuration is difficult.

Moreover, in the Clements mesh described in Non-Patent Literature 1, there is an uncalibrated MZI always in a waveguide route of light from an input node to which the light is input to an output node from which light is output, and therefore detection accuracy of light in the output node deteriorates.

The present disclosure solves the above problem, and an object of the present disclosure is to obtain an optical computing device that can adjust MZIs in a multi-stage MZI array in a short time in the optical computing device including the multi-stage MZI array configured by arranging MZIs of multiple stages in a rectangular shape.

### Solution to Problem

An optical computing device according to the present disclosure includes: a multi-stage MZI array configured by arranging, in an even-numbered row, Mach-Zehnder interferometers arranged in an odd-numbered column, and arranging, in an odd-numbered row, Mach-Zehnder interferometers arranged in an even-numbered column in a matrix of a plurality of rows and a plurality of columns, wherein if a number of Mach-Zehnder interferometers arranged in a first column is N (N represents a natural number equal to or more than two), a number of the rows is 2N+1, and a number of the columns is 2N; and a plurality of monitor photodetectors arranged so as to correspond to Mach-Zehnder interferometers arranged in a first row and respectively connected to first output ports of the Mach-Zehnder interferometers arranged in the first row.

### Advantageous Effects of Invention

According to the present disclosure, it is possible to adjust, in a short time, MZIs in a multi-stage MZI array configured by arranging the MZIs in a rectangular shape in an optical computing device.

### BRIEF DESCRIPTION OF DRAWINGS

FIG. 1 is a schematic view conceptually illustrating a configuration of an optical computing device according to Embodiment 1.

FIG. 2 is a diagram illustrating a configuration of MZIs in the optical computing device according to Embodiment 1.

FIG. 3 is a diagram illustrating the configuration of the MZIs in the optical computing device according to Embodiment 1.

FIG. 4 is a diagram illustrating the configuration of the MZIs in the optical computing device according to Embodiment 1.

FIG. 5 is a flowchart illustrating a procedure of an adjustment method of the MZIs in the optical computing device according to Embodiment 1.

FIG. 6 is a schematic view illustrating a waveguide route of light for adjusting an MZI₃₃ that is an adjustment target in the optical computing device according to Embodiment 1.

FIG. 7 is a schematic view conceptually illustrating a configuration of an optical computing device according to Embodiment 2.

FIG. 8 is a flowchart illustrating a procedure of an adjustment method of MZIs in the optical computing device according to Embodiment 2.

FIG. 9 is a schematic view illustrating waveguide routes of light for adjusting an MZI₉ and an MZI₂₅ that are adjustment targets in the optical computing device according to Embodiment 2.

FIG. 10 is a schematic view conceptually illustrating a configuration of an optical computing device according to Embodiment 3.

FIG. 11 is a schematic view conceptually illustrating a configuration of an optical computing device according to Embodiment 4.

### DESCRIPTION OF EMBODIMENTS

### Embodiment 1

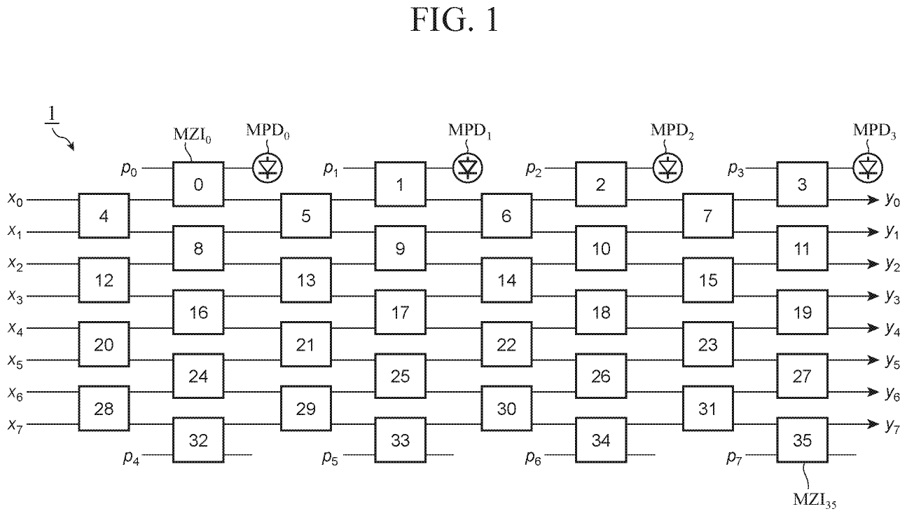

An optical computing device according to Embodiment 1 will be described with reference to FIGS. 1 to 6.

The optical computing device according to Embodiment 1 is an optical computing device that includes an optical computing circuit that uses an analog computing technique of performing a linear operation that uses an interference of light traveling through an optical waveguide.

The optical computing circuit includes a Clements type multi-stage MZI array that is formed on a surface of a substrate and employs a rectangular arrangement configuration.

The optical computing device according to Embodiment 1 includes a multi-stage MZI array 1 and a plurality of monitor photodetectors MPD.

The multi-stage MZI array 1 is an integrated type optical unitary converter that performs unitary conversion on an optical signal input to an input node and outputs the optical signal to an output node.

The multi-stage MZI array 1 is configured by arranging, in even-numbered rows, Mach-Zehnder Interferometers (hereinafter, referred to as MZIs) arranged in odd-numbered columns, and arranging, in odd-numbered rows, MZIs arranged in even-numbered columns in a matrix of a plurality of rows and a plurality of columns to arrange the MZIs in a rectangular shape.

Each MZI includes a first input port Port 1, a second input port Port 2, a first output port Port 3, and a second output port Port 4.

The plurality of monitor photodetectors MPD are each a photodiode connected to the first output port of the corresponding MZI arranged in the first row.

In Embodiment 1, if the number of MZIs arranged in the first column, that is, the number of MZIs at an input stage is N (N represents a natural number equal to or more than two), the number of rows is 2N+1 and the number of columns, that is, the number of stages is 2N in the multi-stage MZI array 1.

The number of MZIs arranged in each row is N.

Note that the number of stages may be smaller than 2N.

An index for an MZI is assigned as follows.

That is, an index of an MZI in the first row and the second column is 0, indices of MZIs arranged in the first row are increased by one in order of columns, an MZI in the second row and the first column is arranged after an MZI in the first row and the Nth column, indices of MZIs arranged in the second row are increased by one in order of columns, and indices up to [N×(2N+1)−1] are assigned up to the MZI in a 2N+1th row and the Nth column in order likewise.

In each row, indices of arranged MZIs take smaller numbers as the number of columns is smaller.

In the following description, when each MZI is specified individually, it will be described as an MZIᵢ, wherein i represents an index number from 0 to [N×(2N+1)−1].

Furthermore, the following description will be given citing an example of a 4×4 Clements type multi-stage MZI array including four MZIs arranged at an input stage, and including eight input nodes and eight output nodes as illustrated in FIG. 1.

In FIG. 1, numbers 0 to 35 encircled by square frames indicate MZIs, and indicate index numbers of the MZIs.

In the multi-stage MZI array 1 illustrated in FIG. 1, N represents four, the number of rows is 9(2N+1), the number of columns is 8(2N), the input stage is the first column, and an output stage is the eighth column that is the last column.

MZIs of indices 0 to 4 are arranged in the first row, MZIs of indices 5 to 7 are arranged in the second row, MZIs of indices 8 to 11 are arranged in the third row, MZIs of indices 12 to 15 are arranged in the fourth row, MZIs of indices 16 to 19 are arranged in the fifth row, MZIs of indices 20 to 23 are arranged in the sixth row, MZIs of indices 24 to 27 are arranged in the seventh row, MZIs of indices 28 to 31 are arranged in the eighth row, and MZIs of indices 32 to 35 are arranged in the ninth row.

The number of MZIs arranged in each row is 4(N).

Accordingly, optical signals propagate through the same number of MZIs in all routes from the input nodes to the output nodes.

As a result, waveguide loss of each route becomes constant in the multi-stage MZI array, so that route symmetry is good.

The first input ports Port 1 and the second input ports Port 2 of the MZIs arranged at the input stage are each connected to input nodes x₀ to x₇ in order from an MZI₄ arranged in the second row, an MZI₁₂ arranged in the fourth row, an MZI₂₀ arranged in the sixth row, and an MZI₂₆ arranged in the eighth row.

The input nodes x₀ to x₇ are connected to light emitting elements (not illustrated) that are light emitting diodes that output optical signals.

The second output port Port 4 of an MZI₃ arranged in the first row among MZIs arranged in the eighth column that is the last stage is connected to an output node y₀.

The first output port Port 3 of an MZI₃₅ arranged in the ninth row that is the lowermost row among the MZIs arranged in the last stage is connected to an output node y₇.

The first output ports Port 3 and the second output ports Port 4 of an MZI₁₁ arranged in the third row between the first row and the ninth row, an MZI₁₉ arranged in the fifth row, and an MZI₂₇ arranged in the seventh row among the MZIs arranged in the last stage are connected to output nodes y₁ to y₆ in order.

The output nodes y₀ to y₇ are connected to photodetectors (not illustrated) that are photodetectors to which optical signals are input.

An MZI₀, an MZI₁, an MZI₂, and the MZI₃ arranged in the first row include the first input ports Port 1 connected to monitor input nodes p₀ to p₃, the second input ports Port 2 connected via the optical waveguide to the first output ports Port 3 of the MZI₄ to an MZI₇ arranged in the adjacent previous column in the second row, and the first output ports Port 3 connected to corresponding monitor photodetectors MPD₀ to MPD₃.

Each MZIᵢ except MZIs at the input stage and the output stage and in the first row and the lowermost row includes the first input port Port 1 connected via the optical waveguide to the second output port Port 4 of an MZI arranged in an adjacent previous column in an adjacent previous row, and the second input port Port 2 connected via the optical waveguide to the first output port Port 3 of an MZI arranged in the adjacent previous column in an adjacent subsequent row.

An MZI₃₂, an MZI₃₃, an MZI₃₄, and the MZI₃₅ arranged in the ninth row that is the lowermost row include the first input ports Port 1 connected via the optical waveguide to the second output ports Port 4 of the MZI₂₈ to the MZI₃₁ arranged in the adjacent previous column in the eighth row, and the second input ports Port 2 connected to corresponding monitor input nodes p₄ to p₇.

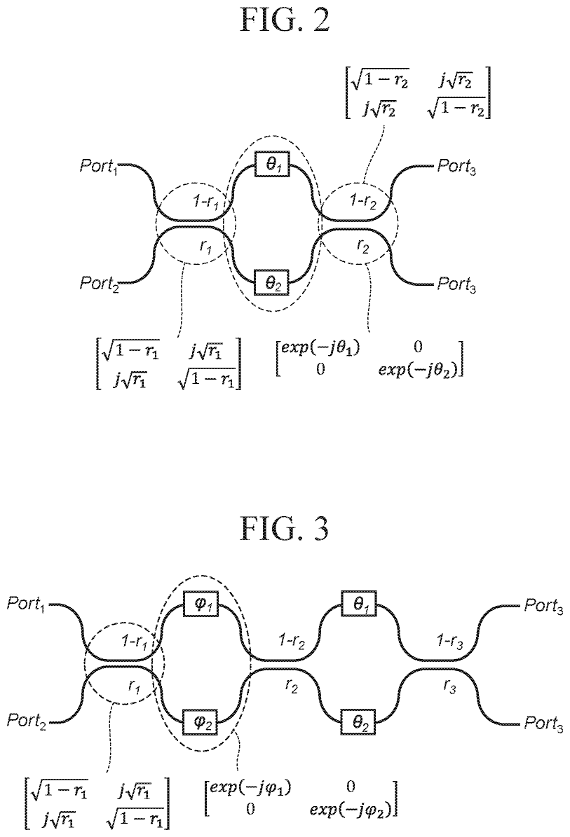

Each of the MZI₀ to the MZI₃₅ is one of the MZIs illustrated in FIGS. 2 to 4 and configured in such a way that splitting ratio manufacturing variations (splitting ratio variations) or the like can be compensated therefor by adjustment.

The MZI illustrated in FIG. 2 includes a first optical waveguide that connects the first input port Port 1 and the first output port Port 3, and a second optical waveguide that connects the second input port Port 2 and the second output port Port 4, and includes a θ phase shifter.

The MZI illustrated in FIG. 3 includes a first optical waveguide that connects the first input port Port 1 and the first output port Port 3, and a second optical waveguide that connects the second input port Port 2 and the second output port Port 4, and includes a φ phase shifter and a θ phase shifter.

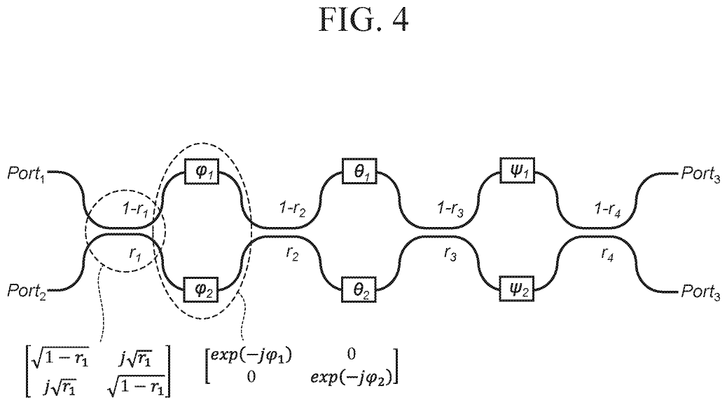

The MZI illustrated in FIG. 4 includes the first optical waveguide that connects the first input port Port 1 and the first output port Port 3, and the second optical waveguide that connects the second input port Port 2 and the second output port Port 4, and includes a φ phase shifter, a θ phase shifter, and a ψ phase shifter.

Each MZI illustrated in FIGS. 2 to 4 may enter two states of a through state where input light to the first input port Port 1 is output to the first output port Port 3, and input light to the second input port Port 2 is output to the second output port Port 4, and a cross state where input light to the first input port Port 1 is output to the second output port Port 4, and input light to the second input port Port 2 is output to the first output port Port 3.

Each MZI illustrated in FIGS. 2 to 4 is made using a semiconductor process, and the first optical waveguide and the second optical waveguide are formed of optical waveguides by using monocrystalline silicon called silicon photonics as a core material.

Note that silicon nitride (SiN), alumina, quartz, or the like may be used instead of monocrystalline silicon as the core material for forming the optical waveguides.

The monitor photodetectors MPD₀ to MPD₃ are each a photodiode that is applied as a photodiode having a pin structure, and for which germanium having good compatibility with a silicon photonics manufacturing process is used as a material.

Note that, instead of the photodiode for which germanium is used, a photodiode formed by integrating compound semiconductors such as InGaAs by dissimilar material bonding may be used.

Next, an adjustment method of MZIs in the optical computing device according to Embodiment 1 will be described.

That is, a procedure of the adjustment method of the MZIs of optimizing a phase adjustment area per MZIᵢ to compensate for a splitting ratio variation of the MZIᵢ will be described.

According to the adjustment method of the MZIs in the optical computing device according to Embodiment 1, the MZIᵢ that is an adjustment target for which a phase error is compensated is adjusted by setting, to a through state, MZIs arranged in a previous column of the adjustment target MZIᵢ in the optical waveguide passing through the adjustment target MZIᵢ, setting, to a cross state, MZIs arranged in a subsequent column in the optical waveguide, and compensating for a splitting ratio variation of the adjustment target MZIᵢ.

According to the adjustment method of the MZIs in the optical computing device according to Embodiment 1, the adjustment target MZIᵢ arranged in the first row is adjusted by inputting an optical signal to the first input port Port 1 of the adjustment target MZIᵢ, and outputting the optical signal to a monitor photodetector MPDₖ connected to the first output port Port 3 of the adjustment target MZIᵢ, and the adjustment target MZIᵢ arranged in second and subsequent rows is adjusted using only the adjusted MZIᵢ for the optical waveguide.

The adjustment method of the MZIs in the optical computing device according to Embodiment 1 is performed on an MZI of the index 0 to an MZI of the index [N×(2N+1)−1] in order of indices.

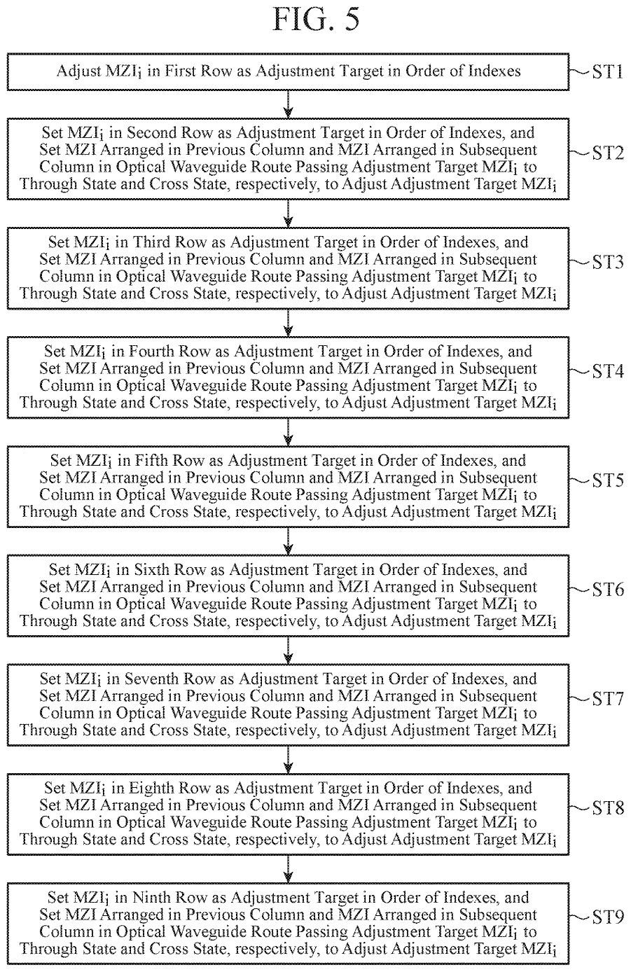

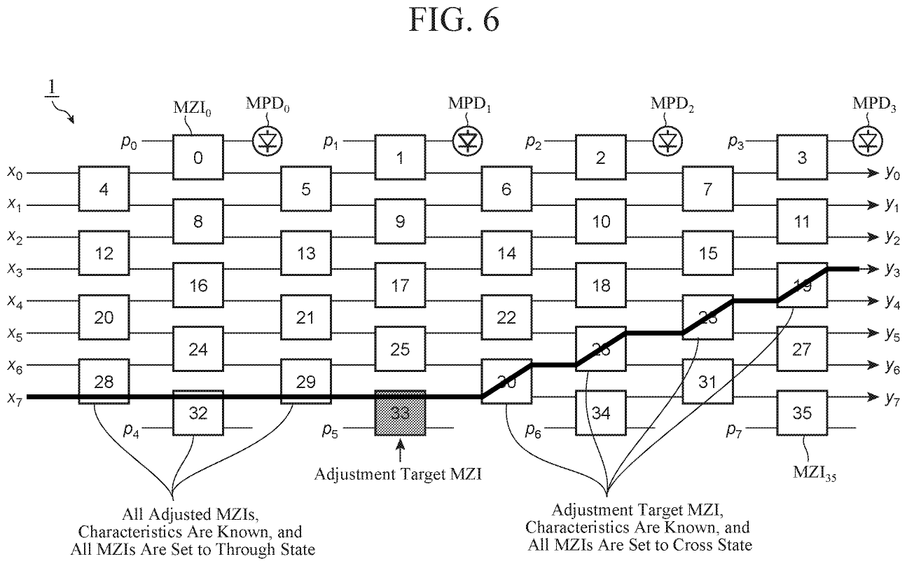

Hereinafter, a specific procedure of the adjustment method of the MZIs in the optical computing device according to Embodiment 1 will be described in an example where N represents four with reference to FIGS. 5 and 6.

In step ST1, the MZI₀ to the MZI₃ arranged in the first row are adjusted as adjustment targets in order of indices.

That is, each of the MZI₀ to the MZI₃ is adjusted by inputting light to the corresponding monitor input nodes p₀ to p₃ in order of the indices, monitoring the light by the corresponding monitor photodetectors MPD₀ to MPD₃, and compensating for the splitting ratio variation of each of the MZI₀ to the MZI₃. After adjustment, each of the MZI₀ to the MZI₃ is set to the through state.

The optical waveguide route for adjustment will be described below.

The adjustment target MZI₀ is adjusted in an optical waveguide route of p₀→MZI₀→MPD₀ for which the monitor input node p₀ is used and the photodetector is used as MPD₀.

In the following description, since description becomes complicated, reference numerals denote optical waveguide routes.

As for the adjustment target MZI₁, the optical waveguide route is p₁→MZI₁→MPD₁.

As for the adjustment target MZI₂, the optical waveguide route is p₂→MZI₂→MPD₂.

As for the adjustment target MZI₃, the optical waveguide route is p₃→MZI₃→MPD₃.

In step ST1, adjustment of the MZI₀ to the MZI₃ arranged in the first row is completed, and characteristics become known.

In step ST2, the MZI₄ to the MZI₇ arranged in the second row are adjusted as adjustment targets in order of indices.

At this time, light is input from the input node x₀ to the first input port Port 1 of the MZI₄ at the input stage.

Furthermore, MZIs arranged in the previous column in the optical waveguide route passing through the adjustment target are set to the through state, and MZIs arranged in the subsequent column are set to the cross state.

In the optical waveguide route described below, a state of the MZIᵢ is indicated as the through state by assigning [T] to the tail of the MZIᵢ and as the cross state by assigning [C] to the tail of the MZIᵢ.

As for the adjustment target MZI₄, the optical waveguide route is x₀→MZI₄→MZI₀[C]→MPD₀. MZI₄ is set to the through state after adjustment, and the MZI₀ is also set to the through state.

As for the adjustment target MZI₅, the optical waveguide route is x₀→MZI₄[T]→MZI₀[T]→MZI₅→MZI₁[C]→MPD₁. MZI₅ is set to the through state after adjustment, and the MZI₁ is also set to the through state.

As for the adjustment target MZI₆, the optical waveguide route is x₀→MZI₄[T]→MZI₀[T]→MZI₅[T]→MZI₁[T]→MZI₆→MZI₂[C]→MPD₂. MZI₆ is set to the through state after adjustment, and the MZI₂ is also set to the through state after adjustment.

As for the adjustment target MZI₇, the optical waveguide route is x₀→MZI₄[T]→MZI₀[T]→MZI₅[T]→MZI₁[T]→MZI₆[T]→MZI₂[T]→MZI₇→MZI₃[C]→MPD₃. MZI₇ is set to the through state after adjustment, and the MZI₃ is also set to the through state.

In short, light is input to each of the MZI₄ to the MZI₇ arranged in the second row from the input node x₀, and is monitored by the monitor photodetectors MPD₀ to MPD₃.

When the MZI₄ to the MZI₇ arranged in the second row are adjusted, and until input light is input from the input node x₀, and light output from the adjustment target reaches each of the monitor photodetector MPD₀ to MPD₃, light passes through the MZI whose characteristics are known and that has already been adjusted, so that the monitor photodetector MPD₀ to MPD₃ can each accurately extract only the characteristics of the adjustment target MZI.

Furthermore, the light does not pass through an MZI whose state is unknown as to the through state or the cross state, so that each of all the monitor photodetectors MPD₀ to MPD₃ can detect the light (except power lost due to waveguide loss) guided in an adjustment waveguide route, and it is possible to maximize the light intensity at a time of adjustment. Consequently, it is possible to maximize a signal-to-noise ratio, and perform accurate adjustment.

In step ST3, an MZI₈ to the MZI₁₁ arranged in the third row are adjusted as adjustment targets in order of indices.

At this time, light is input from the input node x₁ to the second input port Port 2 of the MZI₄ at the input stage.

Furthermore, each time the adjustment target is adjusted, MZIs arranged in the previous column in the optical waveguide route passing through the adjustment target are set to the through state, and MZIs arranged in the subsequent column are set to the cross state.

As for the adjustment target MZI₈, the optical waveguide route is x₁→MZI₄[T]→MZI₈→MZI₅[C]→MZI₁[C]→MPD₁.

As for the adjustment target MZI₉, the optical waveguide route is x₁→MZI₄[T]→MZI₈[T]→MZI₅[T]→MZI₉→MZI₆[C]→MZI₂[C]→MPD₂.

As for the adjustment target MZI₁₀, the optical waveguide route is x₁→MZI₄[T]→MZI₈[T]→MZI₅[T]→MZI₉[T]→MZI₆[T]→MZI₁₀→MZI₇[C]→MZI₃[C]→MPD₃.

As for the adjustment target MZI₁₁, the optical waveguide route is x₁→MZI₄[T]→MZI₈[T]→MZI₅[T]→MZI₉[T]→MZI₆[T]→MZI₁₀[T]→MZI₇[T]→MZI₁₁→y₁.

The adjustment target MZI₁₁ is monitored by the photodetector connected to the output node y₁.

In the following description, the output node indicated in the optical waveguide route for adjustment includes the photodetector connected to the output node.

In short, light is input to each of the MZI₈ to the MZI₁₁ arranged in the third row from the input node x₁, and is monitored by the monitor photodetectors MPD₁ to MPD₃ and the photodetector connected to the output node y₁.

When the MZI₈ to the MZI₁₁ arranged in the third row are adjusted, light passes through the MZI whose characteristics are known and that has already been adjusted, so that it is possible to more accurately extract only the characteristics of the adjustment MZI.

Furthermore, the light does not pass through an MZI whose state is unknown as to the through state or the cross state, so that it is possible to detect all of the light guided in the adjustment waveguide route, and it is possible to maximize the light intensity at the time of adjustment. Consequently, it is possible to maximize a signal-to-noise ratio, and perform accurate adjustment.

In step ST4, the MZI₁₂ to an MZI₁₅ arranged in the fourth row are adjusted as adjustment targets in order of indices.

At this time, light is input from the input node x₂ to the first input port Port 1 of the MZI₁₂ at the input stage.

Furthermore, each time the adjustment target is adjusted, MZIs arranged in the previous column in the optical waveguide route passing through the adjustment target are set to the through state, and MZIs arranged in the subsequent column are set to the cross state.

As for the adjustment target MZI₁₂, the optical waveguide route is x₂→MZI₁₂→MZI₈[C]→MZI₅[C]→MZI₁[C]→MPD₁.

As for the adjustment target MZI₁₃, the optical waveguide route is x₂→MZI₁₂[T]→MZI₈[T]→MZI₁₃→MZI₉[C]→MZI₆[C]→MZI₂[C]→MPD₂.

As for the adjustment target MZI₁₄, the optical waveguide route is x₂→MZI₁₂[T]→MZI₈[T]→MZI₁₃[T]→MZI₉[T]→MZI₁₄→MZI₁₀[C]→MZI₇[C]→MZI₃[C]→MPD₃.

As for the adjustment target MZI₁₅, the optical waveguide route is x₂→MZI₁₂[T]→MZI₈[T]→MZI₁₃[T]→MZI₉[T]→MZI₁₄[T]→MZI₁₀[T]→MZI₁₅→MZI₁₁[C]→y₁.

In short, light is input to each of the MZI₁₂ to the MZI₁₅ arranged in the fourth row from the input node x₂, and is monitored by the monitor photodetectors MPD₁ to MPD₄ and the photodetector connected to the output node y₁.

When the MZI₁₂ to the MZI₁₅ arranged in the fourth row are adjusted, light passes through the MZI whose characteristics are known and that has already been adjusted, so that it is possible to more accurately extract only the characteristics of the adjustment target MZI.

Furthermore, the light does not pass through an MZI whose state is unknown as to the through state or the cross state, so that it is possible to detect all of the light guided in the adjustment waveguide route, and it is possible to maximize the light intensity at the time of adjustment. Consequently, it is possible to maximize a signal-to-noise ratio, and perform accurate adjustment.

In step ST5, an MZI₁₆ to the MZI₁₉ arranged in the fifth row are adjusted as adjustment targets in order of indices.

At this time, light is input from the input node x₃ to the second input port Port 2 of the MZI₁₂ at the input stage.

Furthermore, each time the adjustment target is adjusted, MZIs arranged in the previous column in the optical waveguide route passing through the adjustment target are set to the through state, and MZIs arranged in the subsequent column are set to the cross state.

As for the adjustment target MZI₁₆, the optical waveguide route is x₃→MZI₁₂[T]→MZI₁₆→MZI₁₃[C]→MZI₉[C]→MZI₆[C]→MZI₂[C]→MPD₂.

As for the adjustment target MZI₁₇, the optical waveguide route is x₃→MZI₁₂[T]→MZI₁₆[T]→MZI₁₃[T]→MZI₁₇→MZI₁₄[C]→MZI₁₀[C]→MZI₇[C]→MZI₃[C]→MPD₃.

As for the adjustment target MZI₁₈, the optical waveguide route is x₃→MZI₁₂[T]→MZI₁₆[T]→MZI₁₃[T]→MZI₁₇[T]→MZI₁₄[T]→MZI₁₈→MZI₁₅[C]→MZI₁₁[C]→y₁.

As for the adjustment target MZI₁₉, the optical waveguide route is x₃→MZI₁₂[T]→MZI₁₆[T]→MZI₁₃[T]→MZI₁₇[T]→MZI₁₄[T]→MZI₁₈[T]→MZI₁₅[T]→MZI₁₉→y₃.

In short, light is input to each of the MZI₁₆ to the MZI₁₉ arranged in the fifth row from the input node x₃, and is monitored by the monitor photodetectors MPD₂ and MPD₃ and the photodetectors connected to the output nodes y₁ and y₃.

When the MZI₁₆ to the MZI₁₉ arranged in the fifth row are adjusted, light passes through the MZI whose characteristics are known and that has already been adjusted, so that it is possible to more accurately extract only the characteristics of the adjustment target MZI.

Furthermore, the light does not pass through an MZI whose state is unknown as to the through state or the cross state, so that it is possible to detect all of the light guided in the adjustment waveguide route, and it is possible to maximize the light intensity at the time of adjustment. Consequently, it is possible to maximize a signal-to-noise ratio, and perform accurate adjustment.

In step ST6, the MZI₂₀ to an MZI₂₃ arranged in the sixth row are adjusted as adjustment targets in order of indices.

At this time, light is input from the input node x₄ to the first input port Port 1 of the MZI₂₀ at the input stage.

Furthermore, each time the adjustment target is adjusted, MZIs arranged in the previous column in the optical waveguide route passing through the adjustment target are set to the through state, and MZIs arranged in the subsequent column are set to the cross state.

As for the adjustment target MZI₂₀, the optical waveguide route is x₄→MZI₂₀→MZI₁₆[C]→MZI₁₃[C]→MZI₉[C]→MZI₆[C]→MZI₂[C]→MPD₂.

As for the adjustment target MZI₂₁, the optical waveguide route is x₄→MZI₂₀[T]→MZI₁₆[T]→MZI₂₁→MZI₁₇[C]→MZI₁₄[C]→MZI₁₀[C]→MZI₇[C]→MZI₃[C]→MPD₃.

As for the adjustment target MZI₂₂, the optical waveguide route is x₄→MZI₂₀[T]→MZI₁₆[T]→MZI₂₁[T]→MZI₁₇[T]→MZI₂₂→MZI₁₈[C]→MZI₁₅[C]→MZI₁₁[C]→y₁.

As for the adjustment target MZI₂₃, the optical waveguide route is x₄→MZI₂₀[T]→MZI₁₆[T]→MZI₂₁[T]→MZI₁₇[T]→MZI₂₂[T]→MZI₁₈[T]→MZI₂₃→MZI₁₉→y₃.

In short, light is input to each of the MZI₂₀ to the MZI₂₃ arranged in the sixth row from the input node x₄, and is monitored by the monitor photodetectors MPD₂ and MPD₃ and the photodetectors connected to the output nodes y₁ and y₃.

When the MZI₂₀ to the MZI₂₃ arranged in the sixth row are adjusted, light passes through the MZI whose characteristics are known and that has already been adjusted, so that it is possible to more accurately extract only the characteristics of the adjustment target MZI.

Furthermore, the light does not pass through an MZI whose state is unknown as to the through state or the cross state, so that it is possible to detect all of the light guided in the adjustment waveguide route, and it is possible to maximize the light intensity at the time of adjustment. Consequently, it is possible to maximize a signal-to-noise ratio, and perform accurate adjustment.

In step ST7, an MZI₂₄ to the MZI₂₇ arranged in the seventh row are adjusted as adjustment targets in order of indices.

At this time, light is input from the input node x₅ to the second input port Port 2 of the MZI₂₀ at the input stage.

Furthermore, each time the adjustment target is adjusted, MZIs arranged in the previous column in the optical waveguide route passing through the adjustment target are set to the through state, and MZIs arranged in the subsequent column are set to the cross state.

As for the adjustment target MZI₂₄, the optical waveguide route is x₅→MZI₂₀[T]→MZI₂₄→MZI₂₁[C]→MZI₁₇[C]→MZI₁₄[C]→MZI₁₀[C]→MZI₇[C]→MZI₃[C]→MPD₃.

As for the adjustment target MZI₂₅, the optical waveguide route is x₅→MZI₂₀[T]→MZI₂₄[T]→MZI₂₁[T]→MZI₂₅→MZI₂₂[C]→MZI₁₈[C]→MZI₁₅[C]→MZI₁₁[C]→y₁.

As for the adjustment target MZI₂₆, the optical waveguide route is x₅→MZI₂₀[T]→MZI₂₄[T]→MZI₂₁[T]→MZI₂₅[T]→MZI₂₂[T]→MZI₂₆→MZI₂₃[C]→MZI₁₉[C]→y₃.

As for the adjustment target MZI₂₇, the optical waveguide route is x₅→MZI₂₀[T]→MZI₂₄[T]→MZI₂₁[T]→MZI₂₅[T]→MZI₂₂[T]→MZI₂₆[T]→MZI₂₃[T]→MZI₂₇→y₅.

In short, light is input to each of the MZI₂₄ to the MZI₂₇ arranged in the seventh row from the input node x₅, and is monitored by the monitor photodetector MPD₃ and the photodetectors connected to the output nodes y₁, y₃, and y₅.

When the MZI₂₄ to the MZI₂₇ arranged in the seventh row are adjusted, light passes through the MZI whose characteristics are known and that has already been adjusted, so that it is possible to more accurately extract only the characteristics of the adjustment target MZI.

Furthermore, the light does not pass through an MZI whose state is unknown as to the through state or the cross state, so that it is possible to detect all of the light guided in the adjustment waveguide route, and it is possible to maximize the light intensity at the time of adjustment. Consequently, it is possible to maximize a signal-to-noise ratio, and perform accurate adjustment.

In step ST8, the MZI₂₈ to the MZI₃₁ arranged in the eighth row are adjusted as adjustment targets in order of indices.

At this time, light is input from the input node x₆ to the first input port Port 1 of the MZI₂₈ at the input stage.

Furthermore, each time the adjustment target is adjusted, MZIs arranged in the previous column in the optical waveguide route passing through the adjustment target are set to the through state, and MZIs arranged in the subsequent column are set to the cross state.

As for the adjustment target MZI₂₈, the optical waveguide route is x₆→MZI₂₈→MZI₂₄[C]→MZI₂₁[C]→MZI₁₇[C]→MZI₁₄[C]→MZI₁₀[C]→MZI₇[C]→MZI₃[C]→MPD₃.

As for the adjustment target MZI₂₉, the optical waveguide route is x₆→MZI₂₈[T]→MZI₂₄[T]→MZI₂₉→MZI₂₅[C]→MZI₂₂[C]→MZI₁₈[C]→MZI₁₅[C]→MZI₁₁[C]→y₁.

As for the adjustment target MZI₃₀, the optical waveguide route is x₆→MZI₂₈[T]→MZI₂₄[T]→MZI₂₉[T]→MZI₂₅[T]→MZI₃₀→MZI₂₆[C]→MZI₂₃[C]→MZI₁₉[C]→y₃.

As for the adjustment target MZI₃₁, the optical waveguide route is x₆→MZI₂₈[T]→MZI₂₄[T]→MZI₂₉[T]→MZI₂₅[T]→MZI₃₀[T]→MZI₂₆[T]→MZI₃₁→MZI₂₇[C]→y₅.

In short, light is input to each of the MZI₂₈ to the MZI₃₁ arranged in the eighth row from the input node x₆, and is monitored by the monitor photodetector MPD₃ and the photodetectors connected to the output nodes y₁, y₃, and y₅.

When the MZI₂₈ to the MZI₃₁ arranged in the eighth row are adjusted, light passes through the MZI whose characteristics are known and that has already been adjusted, so that it is possible to more accurately extract only the characteristics of the adjustment target MZI.

Furthermore, the light does not pass through an MZI whose state is unknown as to the through state or the cross state, so that it is possible to detect all of the light guided in the adjustment waveguide route, and it is possible to maximize the light intensity at the time of adjustment. Consequently, it is possible to maximize a signal-to-noise ratio, and perform accurate adjustment.

In step ST9, the MZI₃₂ to the MZI₃₅ arranged in the ninth row are adjusted as adjustment targets in order of indices.

At this time, light is input from the input node x₇ to the second input port Port 2 of the MZI₂₈ at the input stage.

Furthermore, each time the adjustment target is adjusted, MZIs arranged in the previous column in the optical waveguide route passing through the adjustment target are set to the through state, and MZIs arranged in the subsequent column are set to the cross state.

As for the adjustment target MZI₃₂, the optical waveguide route is x₇→MZI₂₈[T]→MZI₃₂→MZI₂₉[C]→MZI₂₅[C]→MZI₂₂[C]→MZI₁₈[C]→MZI₁₅[C]→MZI₁₁[C]→y₁.

As for the adjustment target MZI₃₃, the optical waveguide route is x₇→MZI₂₈[T]→MZI₃₂[T]→MZI₂₉[T]→MZI₃₃→MZI₃₀[C]→MZI₂₆[C]→MZI₂₃[C]→MZI₁₉[C]→y₃. FIG. 6 illustrates the optical waveguide route for adjustment of the adjustment target MZI₃₃ as a bold line.

As for the adjustment target MZI₃₄, the optical waveguide route is x₇→MZI₂₈[T]→MZI₃₂[T]→MZI₂₉[T]→MZI₃₃[T]→MZI₃₀[T]→MZI₃₄→MZI₃₁[C]→MZI₂₇[C]→y₅.

As for the adjustment target MZI₃₅, the optical waveguide route is x₇→MZI₂₈[T]→MZI₃₂[T]→MZI₂₉[T]→MZI₃₃[T]→MZI₃₀[T]→MZI₃₄[T]→MZI₃₁[T]→MZI₃₅→y₇.

In short, light is input to each of the MZI₃₂ to the MZI₃₅ arranged in the ninth row from the input node x₅, and is monitored by the photodetectors connected to the output nodes y₁, y₃, y₅, and y₇.

When the MZI₃₂ to the MZI₃₅ arranged in the ninth row are adjusted, light passes through the MZI whose characteristics are known and that has already been adjusted, so that it is possible to more accurately extract only the characteristics of the adjustment target MZI.

Furthermore, the light does not pass through an MZI whose state is unknown as to the through state or the cross state, so that it is possible to detect all of the light guided in the adjustment waveguide route, and it is possible to maximize the light intensity at the time of adjustment. Consequently, it is possible to maximize a signal-to-noise ratio, and perform accurate adjustment.

Note that, although the example of the optical waveguide route for adjusting the adjustment target MZIᵢ has been described, in short, in a case where the MZIᵢ arranged in the first row is directly monitored by the monitor photodetector MPDₖ and adjusted, and the MZIᵢ arranged in the second and subsequent rows is an adjustment target, only the adjusted MZI for which whether the state thereof is the through state or the cross state has been clarified may be used for the optical waveguide route through which light for adjustment passes through the adjustment target MZIᵢ.

Furthermore, in a case where the MZIᵢ arranged in the second and subsequent rows is an adjustment target, the MZIᵢ is adjusted in order of the indices of the MZIᵢ per row in order from the second row, and only the adjusted MZIs may be used for the optical waveguide route through which light for adjustment passes through the adjustment target MZIᵢ.

The optical computing device according to Embodiment 1 includes the multi-stage MZI array 1 that is configured by arranging in the even-numbered rows the MZIs arranged in the odd-numbered columns, and arranging in the odd-numbered rows the MZIs arranged in the even-numbered columns in the matrix of the plurality of rows and the plurality of columns to arrange the MZIs in a rectangular shape, and the monitor photodetectors MPDₖ that are connected to the first output ports of the MZIs arranged in the first row, so that it is possible to adjust all MZIs constituting the MPDₖ in a short time.

Furthermore, for the adjustment target MZIᵢ monitored by the monitor photodetector MPDₖ, it is possible to reduce the number of adjusted MZIs present in the optical waveguide route through which light passes through the adjustment target MZIᵢ, thereby reducing loss in the optical waveguide route.

As a result, it is possible to increase, for example, maximize the light intensity to be monitored, maximize the signal-to-noise ratio, and accurately adjust MZIs.

Moreover, in the optical computing device according to Embodiment 1, the monitor photodetector MPDₖ can directly monitor and adjust the MZIᵢ arranged in the first row, and adjust the MZIᵢ arranged in the second and subsequent rows in a state where the adjusted MZIs whose characteristics are known are present in the optical waveguide route through which light for adjustment passes through the adjustment target MZIᵢ, and unadjusted MZIs are not present, so that it is possible to accurately extract only the characteristics of the adjustment target MZIᵢ and accurately adjust MZIs.

Furthermore, the optical computing device according to Embodiment 1 can adjust the adjustment target MZIᵢ in a state where MZIs whose state is unknown as to the through state or the cross state are not present in the optical waveguide route through which light for adjustment passes through the adjustment target MZIᵢ, and the monitor photodetector MPDₖ or the photodetector connected to the output node can efficiently detect light propagating in the optical waveguide route through which the light for adjustment passes through the adjustment target MZIᵢ, so that it is possible to increase, for example, maximize the light intensity to be monitored, maximize the signal-to-noise ratio, and accurately adjust MZIs.

### Embodiment 2

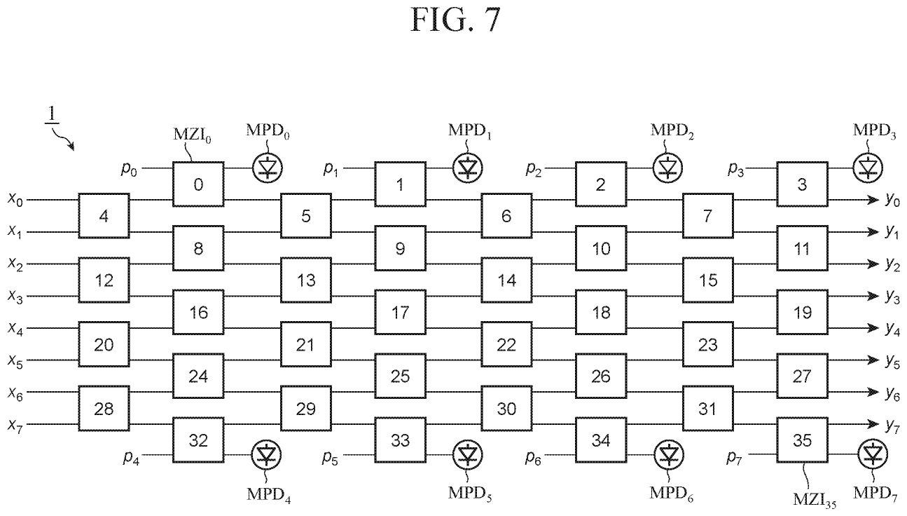

An optical computing device according to Embodiment 2 will be described with reference to FIGS. 7 to 9.

The optical computing device according to Embodiment 2 differs from the optical computing device according to Embodiment 1 in further including a second monitor photodetector MPD connected to the second output port Port 4 of the MZIᵢ arranged in the lowermost row, and other points are the same.

Accordingly, differences will be mainly described below.

Note that, in the following description, monitor photodetectors MPD that are connected to the first output ports of the MZIs arranged in the first row will be referred to as first monitor photodetectors.

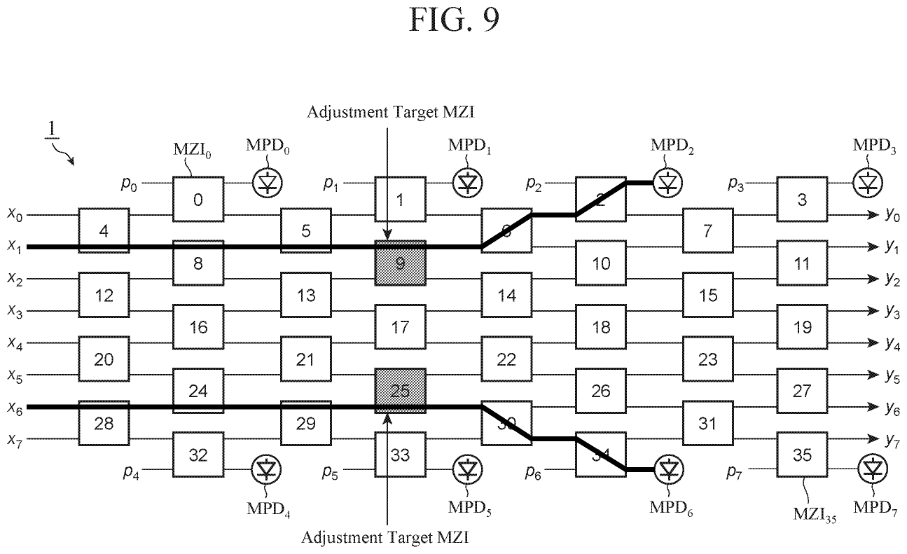

Note that, in FIGS. 7 and 9, the same reference numerals as the reference numerals assigned in FIGS. 1 to 6 indicate identical or corresponding parts.

The MZI₃₂, the MZI₃₃, the MZI₃₄, and the MZI₃₅ arranged in the ninth row that is the lowermost row include the first input ports Port 1 connected via the optical waveguide to the second output ports Port 4 of the MZI₂₈ to the MZI₃₁ arranged in the adjacent previous column in the eighth row, the second input ports Port 2 connected to the corresponding monitor input nodes p₄ to p₇, and the second output ports Port 4 connected to corresponding second monitor photodetectors MPD₄ to MPD₇.

The second monitor photodetectors MPD₄ to MPD₇ are each a photodiode that is applied as a photodiode having a pin structure, and for which germanium having good compatibility with the silicon photonics manufacturing process is used as a material.

Note that, instead of the photodiode for which germanium has been used, a photodiode formed by integrating compound semiconductors such as InGaAs by dissimilar material bonding may be used.

Next, an adjustment method of MZIs in the optical computing device according to Embodiment 2 will be described.

In the multi-stage MZI array 1, a plurality of rows (2N+1) are divided into a first half part (N+1) and a second half part (N), and adjustment is performed row by row in parallel for an MZI arranged in each row of the first half part and an MZI arranged in each row of the second half part, in order from the first row to the lowermost row (N+1) of the first half part and, also, in order from the lowermost row (2N+1) to the uppermost row (N+2) of the second half part, so as to compensate for variations in splitting ratio, wherein adjustment is performed using only the adjusted MZIs as optical waveguide paths.

MZIs of the first half part in the multi-stage MZI array 1 are adjusted in order of indices from an MZI of the index 0 to an MZI of the index [N×(N+1)−1], and MZIs of the second half part are adjusted in order of indices from an MZI of the index [N×(2N+1)−1] to an MZI of the index [N×(N+1)].

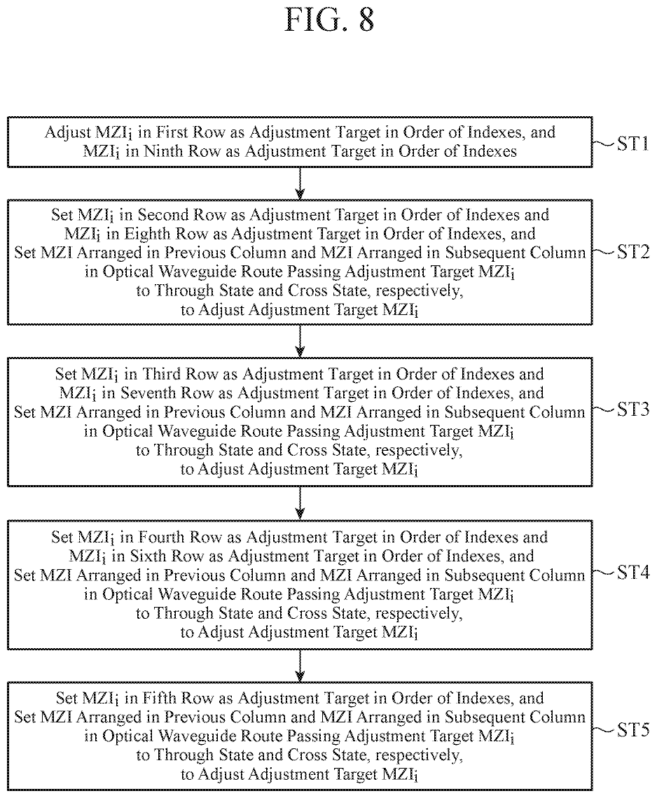

Next, a specific procedure of the adjustment method of MZIs in the optical computing device according to Embodiment 2 will be described in an example where N represents four with reference to FIGS. 8 and 9.

Adjustment of the MZI₀ to the MZI₃ arranged in the first row in the first half part of the multi-stage MZI array 1, and adjustment of the MZI₃₂ to the MZI₃₅ arranged in the ninth row in the second half part are simultaneously performed in parallel.

Adjustment of the MZI₄ to the MZI₇ arranged in the second row in the first half part, and adjustment of the MZI₂₈ to the MZI₃₁ arranged in the eighth row in the second half part are simultaneously performed in parallel.

Adjustment of the MZI₈ to the MZI₁₁ arranged in the third row in the first half part, and adjustment of the MZI₂₄ to the MZI₂₇ arranged in the seventh row in the second half part are simultaneously performed in parallel.

Adjustment of the MZI₁₂ to the MZI₁₅ arranged in the fourth row in the first half part, and adjustment of the MZI₂₀ to the MZI₂₃ arranged in the sixth row in the second half part are simultaneously performed in parallel,

The MZI₁₆ to the MZI₁₉ arranged in the fifth row are adjusted.

Adjustment of the MZI₀ to the MZI₁₉ of the first half part in the multi-stage MZI array 1 is performed in step ST1 to step ST5 similarly to the MZI₀ to the MZI₁₉ described for the adjustment method of MZIs in the optical computing device according to Embodiment 1, and therefore description thereof will be omitted.

In step ST1, the MZI₃₂ to the MZI₃₅ arranged in the ninth row are adjusted as adjustment targets in order of indices simultaneously in association with the MZI₀ to the MZI₃ arranged in the first row.

As for the adjustment target MZI₃₂, the optical waveguide route is p₄→MZI₃₂→MPD₄.

As for the adjustment target MZI₃₃, the optical waveguide route is p₅→MZI₃₃→MPD₅.

As for the adjustment target MZI₃₄, the optical waveguide route is p₆→MZI₃₄→MPD₆.

As for the adjustment target MZI₃₅, the optical waveguide route is p₇→MZI₃₅→MPD₇.

In step ST1, adjustment of the MZI₃₂ to the MZI₃₅ arranged in the ninth row is completed, and characteristics become known.

In step ST2, the MZI₂₈ to the MZI₃₁ arranged in the eighth row are adjusted as adjustment targets in order of indices simultaneously in association with the MZI₄ to the MZI₇ arranged in the second row.

At this time, light is input from the input node x₇ to the second input port Port 2 of the MZI₂₈ at the input stage.

Furthermore, each time the adjustment target is adjusted, MZIs arranged in the previous column in the optical waveguide route passing through the adjustment target are set to the through state, and MZIs arranged in the subsequent column are set to the cross state.

As for the adjustment target MZI₂₈, the optical waveguide route is x₇→MZI₂₈→MZI₃₂[C]→MPD₄. MZI₂₈ is set to the through state after adjustment, and the MZI₃₂ is also set to the through state.

As for the adjustment target MZI₂₉, the optical waveguide route is x₇→MZI₂₈[T]→MZI₂₉→MZI₃₂[T]→MZI₃₃[C]→MPD₅. MZI₂₉ is set to the through state after adjustment, and the MZI₃₃ is also set to the through state.

As for the adjustment target MZI₃₀, the optical waveguide route is x₇→MZI₂₈[T]→MZI₃₂[T]→MZI₂₉[T]→MZI₃₃[T]→MZI₃₀→MZI₃₄[C]→MPD₆. MZI₃₀ is set to the through state after adjustment, and the MZI₃₄ is also set to the through state after adjustment.

As for the adjustment target MZI₃₁, the optical waveguide route is x₇→MZI₂₈[T]→MZI₃₂[T]→MZI₂₉[T]→MZI₃₃[T]→MZI₃₀[T]→MZI₃₄[T]→MZI₃₁→MZI₃₅[C]→MPD₇.

In short, light is input to each of the MZI₂₈ to the MZI₃₁ arranged in the eighth row from the input node x₇, and is monitored by photodetectors connected to the second monitor photodetectors MPD₄ to MPD₇.

When the MZI₂₈ to the MZI₃₁ arranged in the eighth row are adjusted, light passes through the MZI whose characteristics are known and that has already been adjusted, so that it is possible to more accurately extract only the characteristics of the adjustment target MZI.

Furthermore, the light does not pass through an MZI whose state is unknown as to the through state or the cross state, so that it is possible to detect all of the light guided in the adjustment waveguide route, and it is possible to maximize the light intensity at the time of adjustment. Consequently, it is possible to maximize a signal-to-noise ratio, and perform accurate adjustment.

In step ST3, the MZI₂₄ to the MZI₂₇ arranged in the seventh row are adjusted as adjustment targets in order of indices simultaneously in association with the MZI₈ to the MZI₁₁ arranged in the third row.

At this time, light is input from the input node x₆ to the first input port Port 1 of the MZI₂₈ at the input stage.

Furthermore, each time the adjustment target is adjusted, MZIs arranged in the previous column in the optical waveguide route passing through the adjustment target are set to the through state, and MZIs arranged in the subsequent column are set to the cross state.

As for the adjustment target MZI₂₄, the optical waveguide route is x₆→MZI₂₈[T]→MZI₂₄→MZI₂₉[C]→MZI₃₃[C]→MPD₅.

As for the adjustment target MZI₂₅, the optical waveguide route is x₆→MZI₂₈[T]→MZI₂₄[T]→MZI₂₉[T]→MZI₂₅→MZI₃₀[C]→MZI₃₄[C]→MPD₆. FIG. 9 illustrate optical waveguide routes for adjustment of the adjustment target MZI₉ and the adjustment target MZI₃₃ in step ST3 as bold lines.

As for the adjustment target MZI₂₆, the optical waveguide route is x₆→MZI₂₈[T]→MZI₂₄[T]→MZI₂₉[T]→MZI₂₅[T]→MZI₃₀[T]→MZI₂₆→MZI₃₁[C]→MZI₃₅[C]→MPD₇.

As for the adjustment target MZI₂₇, the optical waveguide route is x₆→MZI₂₈[T]→MZI₂₄[T]→MZI₂₉[T]→MZI₂₅[T]→MZI₃₀[T]→MZI₂₆[T]→MZI₃₁[T]→MZI₂₇→y₆.

In short, light is input to each of the MZI₂₄ to the MZI₂₇ arranged in the seventh row from the input node x₆, and is monitored by the monitor photodetectors MPD₅ to MPD₇ and the photodetectors connected to the output node y₆.

When the MZI₂₄ to the MZI₂₇ arranged in the seventh row are adjusted, light passes through the MZI whose characteristics are known and that has already been adjusted, so that it is possible to more accurately extract only the characteristics of the adjustment target MZI.

Furthermore, the light does not pass through an MZI whose state is unknown as to the through state or the cross state, so that it is possible to detect all of the light guided in the adjustment waveguide route, and it is possible to maximize the light intensity at the time of adjustment. Consequently, it is possible to maximize a signal-to-noise ratio, and perform accurate adjustment.

In step ST4, the MZI₂₀ to the MZI₂₃ arranged in the sixth row are adjusted as adjustment targets in order of indices simultaneously in association with the MZI₁₂ to the MZI₁₅ arranged in the fourth row.

At this time, light is input from the input node x₅ to the second input port Port 2 of the MZI₂₀ at the input stage.

Furthermore, each time the adjustment target is adjusted, MZIs arranged in the previous column in the optical waveguide route passing through the adjustment target are set to the through state, and MZIs arranged in the subsequent column are set to the cross state.

As for the adjustment target MZI₂₀, the optical waveguide route is x₅→MZI₂₀→MZI₂₄[C]→MZI₂₉[C]→MZI₃₃[C]→MPD₅.

As for the adjustment target MZI₂₁, the optical waveguide route is x₅→MZI₂₀[T]→MZI₂₄[T]→MZI₂₁→MZI₂₅[C]→MZI₃₀[C]→MZI₃₄[C]→MPD₆.

As for the adjustment target MZI₂₂, the optical waveguide route is x₅→MZI₂₀[T]→MZI₂₄[T]→MZI₂₁[T]→MZI₂₅[T]→MZI₂₂→MZI₂₆[C]→MZI₃₁[C]→MZI₃₅[C]→MPD₇.

As for the adjustment target MZI₂₃, the optical waveguide route is x₅→MZI₂₀[T]→MZI₂₄[T]→MZI₂₁[T]→MZI₂₅[T]→MZI₂₂[T]→MZI₂₆[T]→MZI₂₃→MZI₂₇[C]→y₆.

In short, light is input to each of the MZI₂₀ to the MZI₂₃ arranged in the sixth row from the input node x₄, and is monitored by the monitor photodetectors MPD₅ to MPD₇ and the photodetector connected to the output node y₆.

When the MZI₂₀ to the MZI₂₃ arranged in the sixth row are adjusted, light passes through the MZI whose characteristics are known and that has already been adjusted, so that it is possible to more accurately extract only the characteristics of the adjustment target MZI.

Furthermore, the light does not pass through an MZI whose state is unknown as to the through state or the cross state, so that it is possible to detect all of the light guided in the adjustment waveguide route, and it is possible to maximize the light intensity at the time of adjustment. Consequently, it is possible to maximize a signal-to-noise ratio, and perform accurate adjustment.

Note that the MZI₁₆ to the MZI₁₉ arranged in the fifth row are the first half part for the sake of convenience, yet may be the second half part or may be an intermediate part between the first half part and the second half part.

The optical computing device according to Embodiment 2 has the same effect as that of the optical computing device according to Embodiment 1, and can simultaneously adjust the first half part of MZIs and the second half part of MZIs per row in parallel in the multi-stage MZI array 1, so that it is possible to end adjustment in a shorter time.

### Embodiment 3

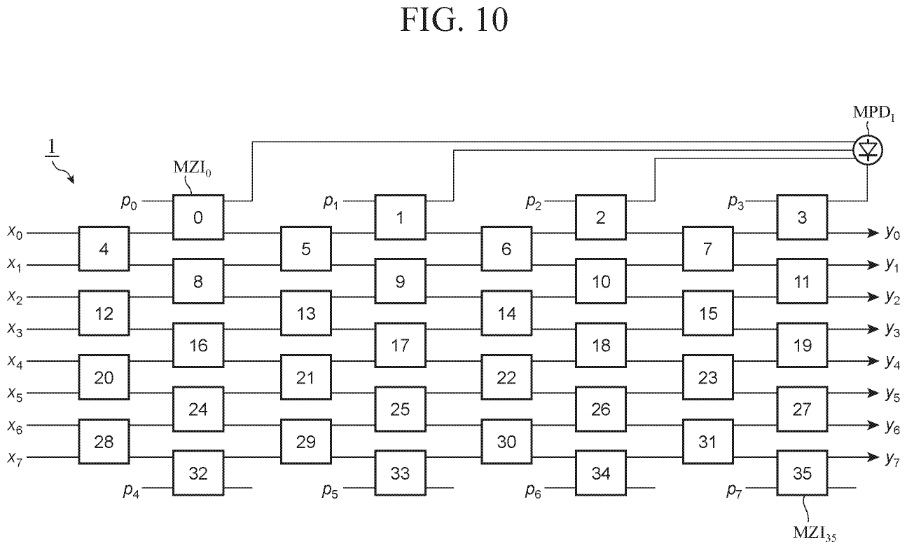

An optical computing device according to Embodiment 3 will be described with reference to FIG. 10.

The optical computing device according to Embodiment 3 differs in arranging one integrated type MPD_{I} commonly integrated for all of the MZI₀ to the MZI₃ arranged in the first row while the monitor photodetectors MPD₀ to MPD₃ are arranged so as to correspond to the MZI₀ to the MZI₃, respectively, arranged in the first row in the optical computing device according to Embodiment 1, and other points are the same.

Accordingly, differences will be mainly described below.

Note that, in FIG. 10, the same reference numerals as the reference numerals assigned in FIGS. 1 to 6 indicate identical or corresponding parts.

The monitor photodetector MPD_{I} is an integrated type photodiode that includes four input ends of a 0th input end to a third input end connected to the first output ports Port 3 of the MZI₀, the MZI₁, the MZI₂, and the MZI₃ arranged in the first row.

The integrated type photodiode is a photodiode of a pin structure that includes a light absorption layer connected to the other end of a waveguide having one end connected to the first output ports Port 3 of the MZI₀, the MZI₁, the MZI₂, and the MZI₃.

A specific procedure of the adjustment method of MZIs in the optical computing device according to Embodiment 3 is substantially the same as the specific procedure of the adjustment method of the MZIs in the optical computing device according to Embodiment 1, and differs in performing monitoring by the monitor photodetector MPD_{I} while the monitor photodetector MPD₁ to MPD₃ perform monitoring in step ST1 to step ST9.

In this regard, in step ST1, although an adjustment order of the MZI₀ to the MZI₃ arranged in the first row is an index order in Embodiment 1, adjustment is performed in reverse order of indices.

That is, in step ST1, each of the MZI₀ to the MZI₃ is adjusted by inputting light to the corresponding monitor input nodes p₀ to p₃ in reverse order of the indices, monitoring the light by the monitor photodetector MPD_{I}, and compensating for the splitting ratio variation of each of the MZI₀ to the MZI₃ after adjustment, each of the MZI₀ to the MZI₃ is set to the through state.

In short, the adjustment target MZI₃ is adjusted in an optical waveguide route of p₃→MZI₃→MPD_{I} for which the input node p₃ is used and the photodetector is used as MPD_{I}. MZI₃ is set to the through state after adjustment.

The optical waveguide route is formed as follows in the following order, and adjusted.

As for the adjustment target MZI₂, the optical waveguide route is p₂→MZI₂→MPD_{I}.

As for the adjustment target MZI₁, the optical waveguide route is p₁→MZI₁→MPD_{I}.

As for the adjustment target MZI₀, the optical waveguide route is p₀→MZI₀→MPD₁.

In step ST1, adjustment of the MZI₀ to the MZI₃ arranged in the first row is completed, and characteristics become known.

In the multi-stage MZI array 1 in which the number of rows is 2N+1 and the number of columns is 2N, the adjustment order of the MZIs arranged in the first row is a reverse order of indices, and an order of N−1, N−2, . . . , 1, and 0, that is, an order of an MZI_{N-1}, an MZI_{N-2}, . . . , the MZI₁, and the MZI₀.

Step ST2 to step ST9 are the same as those in Embodiment 1.

The optical computing device according to Embodiment 3 has the same effect as that of the optical computing device according to Embodiment 1, and includes the integrated monitor photodetector MPD_{I}, so that it is possible to reduce the number of circuit elements and improve a yield rate and manufacturing cost.

### Embodiment 4

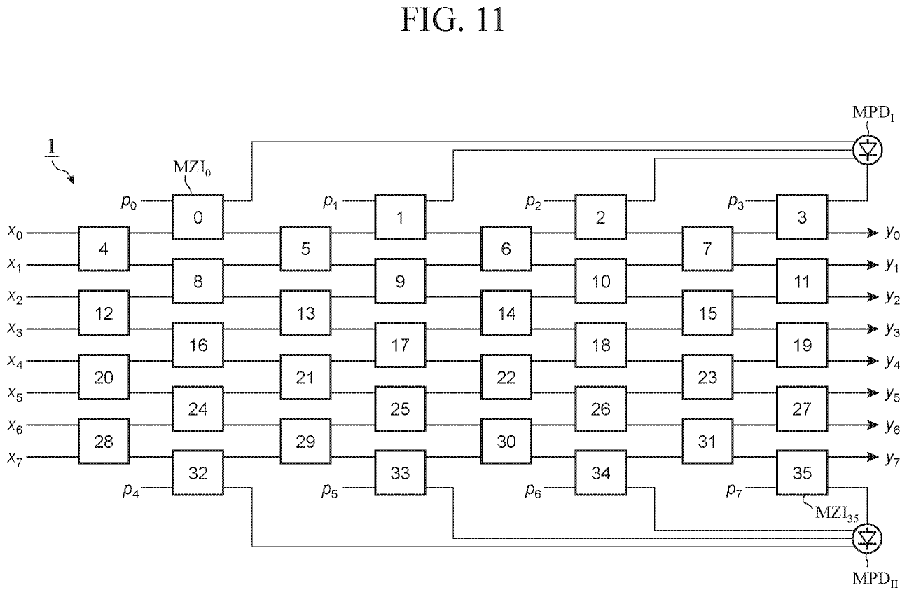

An optical computing device according to Embodiment 4 will be described with reference to FIG. 11.

In the optical computing device according to Embodiment 2, the first monitor photodetectors MPD₀ to MPD₃ are arranged so as to correspond to the MZI₀ to the MZI₃, respectively, arranged in the first row, and the second monitor photodetectors MPD₄ to MPD₇ are arranged so as to correspond to the MZI₃₂ to the MZI₃₅, respectively, arranged in the ninth row that is the lowermost row.

By contrast with this, in the optical computing device according to Embodiment 4, the one integrated type first monitor photodetector MPD_{I} is integrated and arranged commonly for all of the MZI₀ to the MZI₃ arranged in the first row, and one integrated type second monitor photodetector MPD_{II} is integrated and arranged commonly for all of the MZI₃₂ to the MZI₃₅ arranged in the ninth row.

The optical computing device according to Embodiment 4 differs from the optical computing device according to Embodiment 2 in further arranging the first monitor photodetector MPD_{I} and the second monitor photodetector MPD_{II}, and other points are the same.

Accordingly, differences will be mainly described below.

Note that, in FIG. 10, the same reference numerals as the reference numerals assigned in FIGS. 1 to 6 indicate identical or corresponding parts.

The first monitor photodetector MPD_{I} is the integrated type photodiode that includes four input ends of the 0th input end to the third input end connected to the first output ports Port 3 of the MZI₀, the MZI₁, the MZI₂, and the MZI₃ arranged in the first row.

The integrated type photodiode is the photodiode of the pin structure that includes the light absorption layer connected to the other end of the waveguide having the one end connected to the first output ports Port 3 of the MZI₀, the MZI₁, the MZI₂, and the MZI₃.

The second monitor photodetector MPD_{II} is an integrated type photodiode that includes four input ends of a 0th input end to a third input end connected to the first output ports Port 3 of the MZI₃₂, the MZI₃₃, the MZI₃₄, and the MZI₃₅ arranged in the ninth row.

The integrated type photodiode is a photodiode of a pin structure that includes a light absorption layer connected to the other end of the waveguide having the one end connected to the first output ports Port 3 of the MZI₃₂, the MZI₃₃, the MZI₃₄, and the MZI₃₅.

A specific procedure of the adjustment method of MZIs in the optical computing device according to Embodiment 4 is substantially the same as the specific procedure of the adjustment method of the MZIs in the optical computing device according to Embodiment 2, and differs in performing monitoring by the first monitor photodetector MPD_{I} while a first group of the monitor photodetectors MPD₀ to MPD₃ perform monitoring in step ST1 to step ST5, and performing monitoring by the second monitor photodetector MPD_{II} while a second group of the monitor photodetectors MPD₄ to MPD₇ perform monitoring.

In this regard, in step ST1, although the adjustment order of the MZI₀ to the MZI₃ arranged in the first row is the index order, and the adjustment order of the MZI₃₂ to the MZI₃₅ arranged in the ninth row is the index order in Embodiment 1, adjustment is performed on each of the first row and the ninth row in reverse order of indices.

That is, in step ST1, each of the MZI₀ to the MZI₃ is adjusted by inputting light to the corresponding monitor input nodes p₀ to p₃ in reverse order of the indices, monitoring the light by the monitor photodetector MPD_{I}, and compensating for the splitting ratio variation of each of the MZI₀ to the MZI₃, and, at the same time, each of the MZI₃₂ to the MZI₃₅ is adjusted by inputting light to the corresponding monitor input nodes p₄ to p₇ in reverse order of the indices, monitoring the light by the monitor photodetector MPD_{II}, and compensating for the splitting ratio variation of each of the MZI₃₂ to the MZI₃₅.

After adjustment, each of the MZI₀ to the MZI₃ and the MZI₃₂ to the MZI₃₅ is set to the through state.

In short, the adjustment target MZI₃ is adjusted in an optical waveguide route of p₃→MZI₃→MPD_{I} for which the monitor input node p₃ is used and the photodetector is used as MPD_{I}.

At the same time, the adjustment target MZI₃₅ is adjusted in an optical waveguide route of p₇→MZI₃₅→MPD_{II} for which the monitor input node p₇ is used and the photodetector is used as MPD_{II}.

The MZI₃ and the MZI₃₅ are set to the through state after adjustment.

The optical waveguide route is formed as follows in the following order, and adjusted.

As for the adjustment target MZI₂, the optical waveguide route is p₂→MZI₂→MPD_{I}, and, as for the adjustment target MZI₃₄, the optical waveguide route is p₆→MZI₃₄→MPD_{II}.

As for the adjustment target MZI₁, the optical waveguide route is p₁→MZI₁→MPD_{I}, and, as for the adjustment target MZI₃₃, the optical waveguide route is p₅→MZI₃₃→MPD_{II}.

As for the adjustment target MZI₀, the optical waveguide route is p₀→MZI₀→MPD_{I}, and, as for the adjustment target MZI₃₂, the optical waveguide route is p₄→MZI₃₂→MPD_{II}.

In step ST1, adjustment of the MZI₀ to the MZI₃ arranged in the first row and the MZI₃₂ to the MZI₃₅ arranged in the ninth row is completed, and characteristics become known.

In the multi-stage MZI array 1 in which the number of rows is 2N+1 and the number of columns is 2N, the adjustment order of the MZIs arranged in the first row is a reverse order of indices, and an order of N−1, N−2, . . . , 1, and 0, that is, an order of the MZI_{N-1}, the MZI_{N-2}, . . . , the MZI₁, and the MZI₀.

Furthermore, the adjustment order of the MZIs arranged in the (2N+1)th row that is the lowermost row is an order of a larger number of columns that is the reverse order of indices, and an order of (2N+1)N−1, (2N+1)N−2, . . . , and (2N+1)N−N, that is, an order of an MZI_{(2N+1)N-1}, an MZI_{(2N+1)N-2}, . . . , and an MZI_{(2N+1)N-N}.

Step ST2 to step ST5 are the same as those in Embodiment 2.

The optical computing device according to Embodiment 4 has the same effect as that of the optical computing device according to Embodiment 2, and includes the integrated first monitor photodetector MPD_{I} and the integrated second monitor photodetector MPD_{II}, so that it is possible to reduce the number of circuit elements and improve a yield rate and manufacturing cost.

Note that, in Embodiment 4, instead of the integrated type first monitor photodetector MPD_{I} integrated and arranged commonly for all of the MZI₀ to the MZI₃ arranged in the first row, the first monitor photodetectors MPD₀ to MPD₃ may be arranged so as to correspond to the MZI₀ to the MZI₃, respectively, arranged in the first row as described for the optical computing device according to Embodiment 2.

That is, there may be employed a configuration where the first monitor photodetectors MPD₀ to MPD₃ may be arranged so as to correspond to the MZI₀ to the MZI₃, respectively, arranged in the first row, and the integrated type second monitor photodetector MPD_{II} may be integrated and arranged commonly for all of the MZI₃₂ to the MZI₃₅ arranged in the ninth row.

Furthermore, in Embodiment 4, instead of the one integrated type second monitor photodetector MPD_{II} integrated and arranged commonly for all of the MZI₃₂ to the MZI₃₅ arranged in the ninth row, the second monitor photodetectors MPD₄ to MPD₇ may be arranged so as to correspond to the MZI₃₂ to the MZI₃₅, respectively, arranged in the ninth row as described for the optical computing device according to Embodiment 2.

That is, there may be employed a configuration where the one integrated type first monitor photodetector MPD₁ may be integrated and arranged commonly for all of the MZI₀ to the MZI₃ arranged in the first row, and the second monitor photodetectors MPD₄ to MPD₇ may be arranged so as to correspond to the MZI₃₂ to the MZI₃₅, respectively, arranged in the ninth row.

Note that the embodiments can be freely combined, any components in the embodiments can be modified, or any components in the embodiments can be omitted.

### Industrial Applicability

An optical computing device according to the present disclosure is applied to applications that use an analog computing technique such as machine learning and quantum computing.

### REFERENCE SIGNS LIST

1: Multi-stage MZI array, MZI₀ to the MZI₃₅: Mach-Zehnder interferometer, MPD₀ to MPD₃, MPD_{I}: (First) monitor photodetector, MPD₄ to MPD₇, MPD_{II}: Second monitor photodetector, x₀ to x₇: Input node, y₀ to y₇: Output node

1. An optical computing device comprising:
a multi-stage MZI array configured by arranging, in an even-numbered row, Mach-Zehnder interferometers arranged in an odd-numbered column, and arranging, in an odd-numbered row, Mach-Zehnder interferometers arranged in an even-numbered column in a matrix of a plurality of rows and a plurality of columns, wherein if a number of Mach-Zehnder interferometers arranged in a first column is N (N represents a natural number equal to or more than two), a number of the rows is 2N+1, and a number of the columns is 2N; and
a plurality of monitor photodetectors arranged so as to correspond to Mach-Zehnder interferometers arranged in a first row and respectively connected to first output ports of the Mach-Zehnder interferometers arranged in the first row.

2. An optical computing device comprising:
a multi-stage MZI array configured by arranging, in an even-numbered row, Mach-Zehnder interferometers arranged in an odd-numbered column, and arranging, in an odd-numbered row, Mach-Zehnder interferometers arranged in an even-numbered column in a matrix of a plurality of rows and a plurality of columns, wherein if a number of Mach-Zehnder interferometers arranged in a first column is N (N represents a natural number equal to or more than two), a number of the rows is 2N+1, and a number of the columns is 2N; and
a monitor photodetector commonly arranged for all of the Mach-Zehnder interferometers arranged in a first row and connected to first output ports of Mach-Zehnder interferometers arranged in the first row.

3. The optical computing device according to claim 1, wherein, in the multi-stage MZI array, an index of a Mach-Zehnder interferometer in the first row and a second column is 0, indices of the Mach-Zehnder interferometers arranged in the first row are increased by one in order of columns, a Mach-Zehnder interferometer in a second row and the first column is arranged after a Mach-Zehnder interferometer in the first row and an Nth column, indices of Mach-Zehnder interferometers arranged in the second row are increased by one in order of columns, and indices up to [N×(2N+1)−1] are assigned up to a Mach-Zehnder interferometer in a 2N+1th row and the Nth column in order likewise.

4. The optical computing device according to claim 1, further comprising a second monitor photodetector connected to a second output port of a Mach-Zehnder interferometer arranged in a lowermost row.

5. An optical computing device comprising:
a multi-stage MZI array configured by arranging, in an even-numbered row, Mach-Zehnder interferometers arranged in an odd-numbered column, and arranging, in an odd-numbered row, Mach-Zehnder interferometers arranged in an even-numbered column in a matrix of a plurality of rows and a plurality of columns, wherein if a number of Mach-Zehnder interferometers arranged in a first column is N (N represents a natural number equal to or more than two), a number of the rows is 2N+1, and a number of the columns is 2N;
a first monitor photodetector connected to a first output port of a Mach-Zehnder interferometer arranged in a first row; and
a plurality of second monitor photodetectors arranged so as to correspond to Mach-Zehnder interferometers arranged in a lowermost row, and respectively connected to second output ports of the Mach-Zehnder interferometers arranged in the lowermost row.

6. The optical computing device according to claim 5, wherein the first monitor photodetector is arranged so as to correspond to each of the Mach-Zehnder interferometers arranged in the first row.

7. An optical computing device comprising:
a multi-stage MZI array configured by arranging, in an even-numbered row, Mach-Zehnder interferometers arranged in an odd-numbered column, and arranging, in an odd-numbered row, Mach-Zehnder interferometers arranged in an even-numbered column in a matrix of a plurality of rows and a plurality of columns, wherein if a number of Mach-Zehnder interferometers arranged in a first column is N (N represents a natural number equal to or more than two), a number of the rows is 2N+1, and a number of the columns is 2N;
a first monitor photodetector connected to a first output port of a Mach-Zehnder interferometer arranged in a first row; and
a plurality of second monitor photodetectors commonly arranged for all of Mach-Zehnder interferometers arranged in a lowermost row, and connected to second output ports of the Mach-Zehnder interferometers arranged in the lowermost row.

8. The optical computing device according to claim 7, wherein the first monitor photodetector is commonly arranged for all of the Mach-Zehnder interferometers arranged in the first row.

9. The optical computing device according to claim 5, wherein, in the multi-stage MZI array, an index of a Mach-Zehnder interferometer in the first row and a second column is 0, indices of the Mach-Zehnder interferometers arranged in the first row are increased by one in order of columns, a Mach-Zehnder interferometer in a second row and the first column is arranged after a Mach-Zehnder interferometer in the first row and an Nth column, indices of Mach-Zehnder interferometers arranged in the second row are increased by one in order of columns, and indices up to [N×(2N+1)−1] are assigned up to a Mach-Zehnder interferometer in a 2N+1th row and the Nth column in order likewise.

10. An adjustment method of Mach-Zehnder interferometers in an optical computing device that includes a multi-stage MZI array configured by arranging, in an even-numbered row, Mach-Zehnder interferometers arranged in an odd-numbered column, and arranging, in an odd-numbered row, Mach-Zehnder interferometers arranged in an even-numbered column in a matrix of a plurality of rows and a plurality of columns, wherein if a number of Mach-Zehnder interferometers arranged in a first column is N (N represents a natural number equal to or more than two), a number of the rows is 2N+1, and a number of the columns is 2N, and a monitor photodetector connected to each of first output ports of Mach-Zehnder interferometers arranged in a first row,
wherein an adjustment target Mach-Zehnder interferometer for which a splitting ratio variation is compensated is adjusted by setting, to a through state, Mach-Zehnder interferometers arranged in a previous column in an optical waveguide route through which light passes through the adjustment target Mach-Zehnder interferometer, and setting, to a cross state, Mach-Zehnder interferometers arranged in a subsequent column in the optical waveguide route, and compensating for the splitting ratio variation in the adjustment target Mach-Zehnder interferometer, wherein
an adjustment target Mach-Zehnder interferometer arranged in the first row is adjusted by inputting an optical signal to a first input port of the adjustment target Mach-Zehnder, and outputting the optical signal to the monitor photodetector connected to the first output port of the adjustment target Mach-Zehnder interferometer, and
adjustment target Mach-Zehnder interferometers arranged in second and subsequent rows are adjusted by using only an adjusted Mach-Zehnder interferometer for the optical waveguide route.

11. The adjustment method of the Mach-Zehnder interferometers in the optical computing device according to claim 10, wherein
the monitor photodetector is arranged so as to correspond to each of the Mach-Zehnder interferometers arranged in the first row, and
the Mach-Zehnder interferometers arranged in the first row are adjusted by inputting an optical signal to first input ports of the Mach-Zehnder interferometers, and outputting the optical signal to the monitor photodetectors connected to the first output ports of the Mach-Zehnder interferometers and corresponding to the Mach-Zehnder interferometers in order from a smaller number of arranged columns.

12. The adjustment method of the Mach-Zehnder interferometers in the optical computing device according to claim 10, wherein
the monitor photodetector is commonly arranged for all of the Mach-Zehnder interferometers arranged in the first row, and
the Mach-Zehnder interferometers arranged in the first row are adjusted by inputting an optical signal to first input ports of the Mach-Zehnder interferometers, and outputting the optical signal to a common monitor photodetector connected to the first output ports of the Mach-Zehnder interferometers in order from a larger number of arranged columns.

13. An adjustment method of Mach-Zehnder interferometers in an optical computing device that includes a multi-stage MZI array configured by arranging, in an even-numbered row, Mach-Zehnder interferometers arranged in an odd-numbered column, and arranging, in an odd-numbered row, Mach-Zehnder interferometers arranged in an even-numbered column in a matrix of a plurality of rows and a plurality of columns, wherein if a number of Mach-Zehnder interferometers arranged in a first column is N (N represents a natural number equal to or more than two), a number of the rows is 2N+1, and a number of the columns is 2N, a first monitor photodetector connected to first output ports of Mach-Zehnder interferometers arranged in a first row, and a second monitor photodetector connected to second output ports of Mach-Zehnder interferometers arranged in a lowermost row, wherein
an adjustment target Mach-Zehnder interferometer for which a splitting ratio variation is compensated and that is arranged in the first row is adjusted by inputting an optical signal to a first input port of the adjustment target Mach-Zehnder interferometer, and outputting the optical signal to the first monitor photodetector connected to the first output port of the adjustment target Mach-Zehnder interferometer, and, simultaneously, an adjustment target Mach-Zehnder interferometer for which a splitting ratio variation is compensated and that is arranged in the lowermost row is adjusted by inputting an optical signal to a second input port of the adjustment target Mach-Zehnder interferometer, and outputting the optical signal to the second monitor photodetector connected to the second output port of the adjustment target Mach-Zehnder interferometer, and
Mach-Zehnder interferometers obtained by dividing a plurality of rows into two of a first half part and a second half part, and being arranged as Mach-Zehnder interferometers arranged in the first half part of rows and as Mach-Zehnder interferometers arranged in the second half part of the rows per row in order from a second row of the first half part to a lowermost row of the first half part or in order from a row that is one row before a lowermost row to an uppermost row of the second half part are adjusted by simultaneously compensating for the splitting ratio variation, and Mach-Zehnder interferometers arranged in each row are adjusted by using only the adjusted Mach-Zehnder interferometer for an optical waveguide route.

14. The adjustment method of the Mach-Zehnder interferometers in the optical computing device according to claim 13, wherein
the first monitor photodetector is arranged so as to correspond to each of the Mach-Zehnder interferometers arranged in the first row,
the second monitor photodetector is arranged so as to correspond to each of the Mach-Zehnder interferometers arranged in the lowermost row,
the Mach-Zehnder interferometers arranged in the first row are adjusted by inputting an optical signal to first input ports of the Mach-Zehnder interferometers, and outputting the optical signal to the first monitor photodetectors connected to the first output ports of the Mach-Zehnder interferometers and corresponding to the Mach-Zehnder interferometers in order from a smaller number of arranged columns, and
the Mach-Zehnder interferometers arranged in the lowermost row are adjusted by inputting an optical signal to first input ports of the Mach-Zehnder interferometers, and outputting the optical signal to the second monitor photodetector connected to the second output ports of the Mach-Zehnder interferometers and corresponding to the Mach-Zehnder interferometers in order from a smaller number of arranged columns.

15. The adjustment method of the Mach-Zehnder interferometers in the optical computing device according to claim 13, wherein
the first monitor photodetector is commonly arranged for all of the Mach-Zehnder interferometers arranged in the first row,
the second monitor photodetector is commonly arranged for all of the Mach-Zehnder interferometers arranged in the lowermost row,
the Mach-Zehnder interferometers arranged in the first row are adjusted by inputting an optical signal to first input ports of the Mach-Zehnder interferometers, and outputting the optical signal to the common first monitor photodetector connected to the first output ports of the Mach-Zehnder interferometers in order from a larger number of arranged columns, and
the Mach-Zehnder interferometers arranged in the lowermost row are adjusted by inputting an optical signal to first input ports of the Mach-Zehnder interferometers, and outputting the optical signal to the common second monitor photodetector connected to the second output ports of the Mach-Zehnder interferometers in order from a smaller number of arranged columns.
